(19) United States
(12) Patent Application Publication
(10) Pub. No.: US 2026/0043451 A1
(43) Pub. Date: Feb. 12, 2026

(54) DAMPING ELEMENT FOR DAMPING VIBRATIONS ON A STORAGE RACK

(71) Applicant: Dematic GmbH, Heusenstamm (DE)

(72) Inventors: Traian Gligor, Krombach (DE); Matthias Wehner, Neu-Isenburg (DE)

(21) Appl. No.: 19/101,678

(22) PCT Filed: Aug. 9, 2022
(86) PCT No.: PCT/EP2022/072351

§ 371 Date: Feb. 6, 2025

(51) Int. Cl. F16F 7/104; B65G 1/04

(52) U.S. Cl. CPC F16F 7/104; B65G 1/0407; F16F 2222/08; F16F 2224/02; F16F 2226/04

(57) ABSTRACT

A damping element for damping vibrations on a storage rack, where the damping element has a housing and a granular damping means filled into the housing The damping element may be frictionally and/or interlockingly fastened to the storage rack solely by virtue of a shape and/or a material of the housing. Also disclosed is an arrangement and a storage system comprising such a damping element.

### CROSS REFERENCE TO RELATED APPLICATION

This is a national stage application of PCT Application No. PCT/EP2022/072351, filed Aug. 9, 2022.

### FIELD OF THE INVENTION

The invention relates to a damping element for damping vibrations on a storage rack, and an arrangement with such a damping element and a storage system having such a damping element.

### BACKGROUND OF THE INVENTION

Vibrations occurring on a storage rack can cause undesired movements of the stored goods stored on the storage rack. In particular, slipping and turning of the stored goods and an associated change in the position of the stored goods on the storage rack are undesired. Such moving stored goods are also referred to as “dancing totes”.

By reason of the stored goods being in a changed position, there may be collisions between the stored goods, when being removed from the storage rack, and a handling device used for their removal, e.g. a rack serving apparatus. The stored goods and/or the handling device may be damaged thereby. As a consequence, this can lead to the handling device failing, whereby e.g. the through-put of a storage system and the process safety of its operation are limited.

In addition, changes in the position of the stored goods on the storage rack which are detected by sensors can lead to an unplanned interruption and therefore disruption in the operation of the storage system. The position of the stored goods on the storage rack must then be corrected, e.g. manually, before the operation of the storage system can be resumed.

### SUMMARY OF THE INVENTION

The object of the present invention is to dampen vibrations occurring on a storage rack by way of a damping element, as well as a storage rack with a damping element and a storage system comprising such a storage rack.

In accordance with an embodiment of the invention, a damping element is provided for damping vibrations on a storage rack, where the damping element comprises a housing and a grain-like damping means introduced into the housing, and where the damping element can be fastened to the storage rack in a force-fitting and/or form-fitting manner exclusively by reason of a shape and/or material of the housing.

In other words, the damping element can be attached to the storage rack securely and easily owing to the shape and/or the material of the housing without additional fastening means. Force-fitting fastening preferably comprises clamping of the housing to the storage rack. Form-fitting fastening preferably comprises laying a housing portion on a contour on the storage rack corresponding to this housing portion. In so doing, the corresponding housing portion can engage into the contour on the storage rack.

In the present case, the shape of the housing is understood to be the whole outer contour of the housing. The shape of the housing thus comprises all external surfaces. The shape and size of the damping element, in particular of the housing, are preferably configured on the basis of geometric features on the storage rack and/or of the vibrations to be damped.

The material of the housing has, in particular in the regions provided for fastening the damping element, a comparatively low bending stiffness and a preferably high level of elasticity. For this purpose, in particular, the housing or the regions provided for the fastening are produced from synthetic material.

The housing comprises in a particular embodiment a beaker-shaped receiving region which serves to receive the grain-like damping means. An inner surface of the receiving region, which faces the grain-like damping means, is not counted as being part of the shape of the housing serving for fastening purposes. The receiving region comprises an opening so that the housing can easily be filled with the grain-like damping means. The opening can preferably be closed with a cover appertaining to the damping element. Alternatively, a contour on the storage rack can also be used to close the receiving region.

The grain-like damping means is used to damp the vibrations occurring on the storage rack. Initially the vibrations are transferred from the storage rack to the grain-like damping means via the housing. The movement of the grain-like damping means in the housing and in particular rubbing of the individual damping means grains against each other produces a damping effect. The intensity or amplitude of the vibrations is thereby reduced. As a result, the vibrations on the storage rack are weakened or compensated for.

The vibrations occurring on the storage rack are induced in particular by a handling device and/or transport vehicle and/or conveying device travelling past the storage rack. The vibrations are caused in particular by unevenness on a travel path, e.g. on a warehouse floor or a rail, contacted by tyres, wheels or rollers used to move the handling device or the transport vehicle or the conveying device. The handling device can be a single-level rack serving apparatus described below or a multi-level rack serving apparatus described below. The transport vehicle can be a driverless transport system (AGV). The conveying device can be a lift or a conveyor belt.

With the damping element in accordance with the invention, vibrations induced into the storage rack can easily be damped. Slipping or turning, i.e. a change of position of the stored goods on the storage rack, can therefore be mitigated or even prevented. Resulting disruptions in the store operation or damage to the stored goods and/or to the handling device used to remove the stored goods from the storage rack can therefore be avoided. The through-put of the storage system and the process safety during operation thereof can therefore be increased owing to the damping element in accordance with the invention.

Provision is made in a particular embodiment for the housing to comprise two wing-like clamping elements, with which the housing can be fastened to the storage rack.

In addition to the above-described receiving region, the housing thus comprises two further regions which serve, preferably exclusively, for fastening the damping element to the storage rack. The housing is preferably formed as one piece, i.e. the receiving region and the wing-like clamping elements form a component. Alternatively, the housing can also be formed of multiple parts.

Each of the two wing-like clamping elements is a planar element which protrudes or stands out from the rest of the parts or regions of the housing, i.e. extends away therefrom. The wing-like clamping elements are preferably disposed spaced apart from each other on the receiving region and protrude therefrom in parallel.

The wing-like clamping elements are flexible and in particular are flat for this purpose. An inner surface and an outer surface of the wing-like clamping elements are thus large in relation to an end face connecting the inner surface and outer surface. The inner surface of one wing-like clamping element and the inner surface of the other wing-like clamping element preferably lie opposite each other.

The actual shape of the wing-like clamping elements is dependent on the geometrical features of the storage rack or on the region of the storage rack, to which the damping element is to be fastened. A further fastening element, such as e.g. a nipple, for producing a form-fitting connection to the storage rack can be provided on the wing-like clamping elements, in particular on the inner surface or the outer surface thereof.

It is feasible for the housing to have more than two wing-like clamping elements. The housing can alternatively or additionally have clamping elements of another shape.

A clamping effect is preferably produced by the wing-like clamping elements, in a mounted state, each pressing with their outer surface outwards against a surface of the storage rack, with which they are in contact. In terms of fastening to the storage rack, i.e. when the damping element is being mounted, the inner surfaces of the wing-like clamping elements are moved towards each other and released after appropriate positioning of the damping element on the storage rack. Since the wing-like clamping elements tend to move away from each other, the clamping can also be referred to as pressure clamping.

It is also possible for the clamping effect to be produced in that the wing-like clamping elements, in the mounted state, each press with their inner surface inwards against a surface of the storage rack, with which they are in contact. In terms of fastening to the storage rack, the inner surfaces of the wing-like clamping elements are moved away from each other, in contrast to the above-described embodiment, and released after appropriate positioning of the damping element on the storage rack. Since the wing-like clamping elements tend to move towards each other, the clamping can also be referred to as traction clamping.

In an advantageous manner, the housing is an injection molded part. The housing is then of comparatively light weight. In addition, the material thickness in different regions of the housing can then easily be varied. This makes it possible to achieve optimal clamping properties of the clamping elements irrespective of the material thickness provided on the receiving region. The formation of the housing as an injection molded part also makes it possible to configure the shape of the housing comparatively freely and to adapt it to the existing features on the storage rack. Furthermore, such a production method facilitates the one-piece formation of the housing and the provision of the further fastening elements thereto. The optionally provided cover is also preferably formed as an injection molded part.

Provision is advantageously made for a grain shape and/or a grain size or granularity of the grain-like damping means to be dependent on a vibration frequency to be damped. In other words, geometric properties of the grain-like damping means, such as shape and/or size of the damping means grains, are selected in dependence upon the vibration frequency to be damped. In so doing, in particular a small grain size or small granularity is provided in the case of high vibration frequencies to be damped and a large grain size or large granularity is provided in the case of low vibration frequencies to be damped.

In the event of different vibration frequencies to be damped, an average value for the vibration frequencies to be damped can serve as a basis for selecting the geometric properties. Alternatively, grain-like damping means with different geometric properties can also be used in order to deal with some or all vibration frequencies to be damped. In particular, such a mixture of different geometric properties is suitable for damping a wide range of vibration frequencies.

It is also feasible for a plurality of damping elements to be fastened to a storage rack, the grain-like damping means of which each have different geometric properties.

The housing which can be filled through the opening makes it possible for the damping means to be replaced easily and therefore to react to changes in the vibration frequency to be damped on the storage rack.

In addition, provision is advantageously made for the grain-like damping means to comprise a powder, in particular flour, and/or a granulate, in particular a rubber granulate, and/or sand. The grain-like damping means can thus also comprise a mixture of powder and granulate, of powder and sand, of granulate and sand or of powder, granulate and sand. How the grain-like damping means is formed or how a mixture is composed depends in particular on the vibration frequency to be damped.

Furthermore, the invention relates to an arrangement with a storage rack, which comprises storage locations for stored goods, and with a damping element in accordance with the invention, wherein the damping element is fastened to the storage rack in a force-fitting and/or form-fitting manner. A single damping element in accordance with the invention or a plurality of damping elements in accordance with the invention can be fastened to the storage rack. By reason of the easy fastening of the damping element to the storage rack, it is possible to retrofit a damping element on a storage rack already in operation. The storage locations for the stored goods are disposed on the storage rack next to each other and one above the other in a plurality of rack levels. Stored goods can be e.g. pallets, containers, crates, boxes, bags and/or individual items.

The arrangement in accordance with the invention has the advantage over a storage rack without a damping element that vibrations occurring on the storage rack are damped and possibly completely compensated for. The arrangement can comprise further storage racks with a damping element or damping elements and/or without a damping element.

Provision is advantageously made for the damping element to be disposed on or in a support pillar and/or a transverse cross member and/or a longitudinal cross member of the storage rack. In other words, the at least one damping element may be preferably disposed on or in a structural element of the storage rack. The structural element then appertains in particular to a standing frame or supporting frame of the storage rack. In addition to the above-mentioned structural elements, the storage rack can have further structural elements, such as e.g. stiffening bars, and other elements, such as e.g. coverings.

The support pillar is a vertical structural element of the storage rack and is in contact with the warehouse floor in particular via an anchoring means. The transverse cross member, also referred to as a transverse bar, and the longitudinal cross member, also referred to as a longitudinal bar, are horizontal structural elements of the storage rack and extend substantially perpendicularly to the support pillars and substantially perpendicularly to each other. One or a plurality of transverse cross member(s) and/or one or a plurality of longitudinal cross member(s) can form a storage location for the stored goods.

The damping element can also be fastened to the storage rack in such a way that this is disposed at the same time in or on a support pillar and a transverse cross member, at the same time in or on a support pillar and a longitudinal cross member, at the same time in or on a transverse cross member and a longitudinal cross member or at the same time in or on a support pillar, a transverse cross member and a longitudinal cross member. By disposing the damping element in or on a structural element, the vibrations can be damped effectively before they are transferred to the stored goods.

The invention also relates to a storage system comprising a storage rack and a rack serving apparatus which can travel along the storage rack and with which the stored goods can be transported. By means of the rack serving apparatus which can travel along the storage rack, the stored goods can be transported between the individual storage locations of the storage rack and preferably between the individual storage locations and locations on the storage rack where goods are placed into and removed from storage. Furthermore, provision can be made for the rack serving apparatus to be suitable for transporting the stored goods from the storage rack to a further storage rack provided in the arrangement.

In addition to the rack serving apparatus, further handling devices and/or transport vehicles and/or conveying devices can be provided in the storage system. The storage system is preferably a partially automated, and more preferably fully automated, storage system. Within the scope of the invention, “partially automated” is understood to mean that some of the handling devices and/or transport vehicles and/or conveying devices used in the storage system are operated in an automated manner. Within the scope of the invention, “fully automated” is understood to mean that all of the handling devices and/or transport vehicles and/or conveying devices used in the storage system are operated in an automated manner.

Vibrations occurring on the storage rack are generated in particular by the handling devices and/or transport vehicles and/or conveying devices provided in the storage system and travelling past the storage rack, and are then induced into the storage rack.

In a particular embodiment the rack serving apparatus is a single-level rack serving apparatus which can travel on two rails, where the rails extend between two storage racks disposed in parallel with each other and separated from each other by a rack aisle, and in each case one of the two rails is fastened to one of the neighbouring storage racks, and where the damping element is disposed on or in one of the two rails. The damping element can also be fastened to the storage rack in such a way that this rack is disposed at the same time in or on one of the two rails and a support pillar and/or a transverse cross member and/or a longitudinal cross member.

The single-level rack serving apparatus, also referred to as a shuttle, in a particular embodiment serves only a single rack level of the storage rack. However, the single-level rack serving apparatus can also be designed in such a way that it can serve a small number of, in particular two or three, rack levels. The rails are provided in one of the rack levels associated with the single-level rack serving apparatus. By means of the two rails, the vibrations generated by the travelling of the single-level rack serving apparatus are induced into the respective storage rack connected to the rail. Stored goods can be loaded into, or unloaded from, the single-level rack serving apparatus on both sides of the rack aisle by means of a load-picking up means in order to place/remove the stored goods into/out of storage. The single-level rack serving apparatus can switch between rack levels via a lift optionally provided in the storage rack.

In order to supply power to the single-level rack serving apparatus, at least one contact line extends in the rails so that the single-level rack serving apparatus does not have to be fitted with a rechargeable battery. Furthermore, a contact line extending in the rails, or a signal transmission integrated into the contact line used for the power supply can be used to transmit control signals. The transmission of control signals can alternatively be effected by radio.

Alternatively, the rack serving apparatus can also be a multi-level rack serving apparatus. This comprises a lower running gear unit, at least one mast and a lifting carriage which can travel on the mast and has a load-picking up means. The multi-level rack serving apparatus is rail-bound on a single track in the generic manner and, in contrast to the above-described embodiment of the rack serving apparatus, serves many, preferably four or more, or all rack levels of a storage rack. The multi-level rack serving apparatus can also serve storage racks disposed in a plurality of rack aisles.

The multi-level rack serving apparatus, also referred to as a stacker crane or storage and retrieval unit, has, in addition to the lower running gear unit, optionally an upper running gear unit which is disposed on an end of the mast remote from the lower running gear unit. The multi-level rack serving apparatus can be guided on a head cross beam via guide rollers provided on the upper running gear unit. The multi-level rack serving apparatus can include further components, such as e.g. a lifting mechanism having a cable or chain drive, ladders and power supplies.

The multi-level rack serving apparatus can be moved in three spatial directions or axes. The lower running gear unit, in particular with the running wheels provided thereon, is used to move the multi-level rack serving apparatus along a rail which is disposed in particular in a rack aisle on a warehouse floor. The mast disposed on the lower running gear unit and disposed substantially vertically to the rail is used to lift and lower the lifting carriage along the mast. The load picking-up means of the lifting carriage can be moved substantially vertically to the rail and substantially vertically to the mast, i.e. transversely to a direction of travel of the multi-level rack serving apparatus and is used to pick up and deliver the stored goods. The vibrations generated by the travelling of the multi-level rack serving apparatus are induced into the warehouse floor in particular via the rail and from the warehouse floor, on which the storage rack also stands, into the storage rack.

Of course, it is feasible for single-level rack serving apparatuses and also multi-level rack serving apparatuses to be provided in a storage system.

Further details of the invention will become clear from the following description of exemplified embodiments by reference to the drawings.

### BRIEF DESCRIPTION OF THE DRAWINGS

FIG. 1 shows a schematic perspective view of an embodiment of the damping element in accordance with the invention;

FIG. 2 shows a schematic perspective view of an embodiment of the arrangement in accordance with the invention;

FIG. 3 shows a schematic cross-sectional view of an embodiment of the storage system in accordance with the invention; and

FIG. 4 shows a schematic cross-sectional view of a further embodiment of the storage system in accordance with the invention.

### DESCRIPTION OF THE PREFERRED EMBODIMENTS

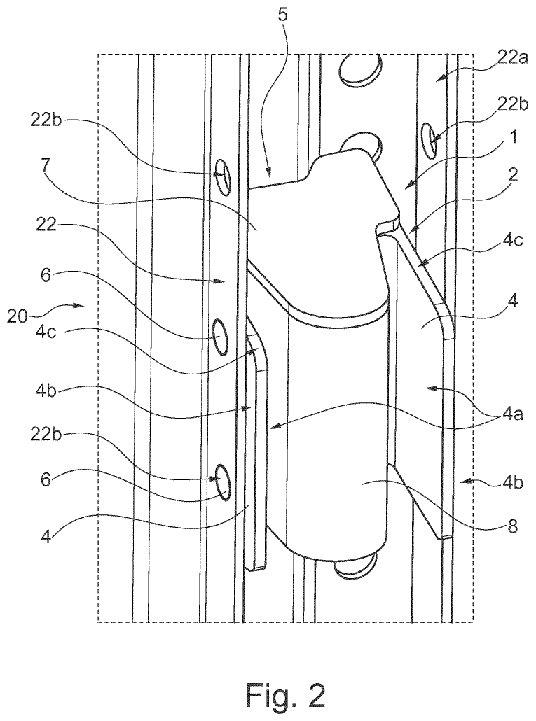

FIG. shows a schematic perspective view of an embodiment of the damping element 1 in accordance with the invention. The damping element 1 serves to damp vibrations on a storage rack 20 and comprises a housing 2 with a receiving region 8 for receiving grain-like damping means. In the present case, the receiving region 8 is beaker-shaped but can also be of another shape. The receiving region 8 can be filled with the grain-like damping means via an opening 3 and can optionally be closed with a cover 7 (see FIG. 2).

In the provided illustration, the grain-like damping means introduced into the housing 2 is not shown. However, this is necessary in order to damp vibrations occurring on a storage rack 20. Initially, the vibrations are transferred from the storage rack 20 to the grain-like damping means via the housing 2. A movement of the grain-like damping means in the housing 2 or in the receiving region 8 and in particular rubbing of the individual damping means grains against each other produces a damping effect. The intensity or amplitude of the vibrations is thereby reduced. As a result, the vibrations on the storage rack 20 are also weakened or compensated for. A grain shape and/or a grain size or granularity of the grain-like damping means can be dependent on a vibration frequency to be damped. The grain-like damping means can comprise a powder, in particular flour, and/or a granulate, in particular a rubber granulate, and/or sand.

The damping element 1 can be fastened to the storage rack 20 in a force-fitting and form-fitting manner exclusively by reason of a shape and/or a material of the housing 2. For this purpose, the housing 2 comprises two wing-like clamping elements 4 in addition to the receiving region 8. The wing-like clamping elements 4 are disposed spaced apart from each other on the receiving region 8 and protrude therefrom in parallel. The damping element 1 can be fastened to a storage rack in a force-fitting manner by means of the wing-like clamping elements 4 (see FIGS. 2 to 4).

In the case of such fastening-in the mounted state shown in FIG. 2—a respective outer surface 4b of the clamping element 4 presses outwards against a surface 22a of the storage rack 20, with which it is in contact, whereby a clamping effect is produced. During mounting of the damping element 1 on the storage rack 20, the inner surfaces 4a of the two wing-like clamping elements 4 have been moved towards each other and released once the damping element 1 has been positioned appropriately on the storage rack 20.

Alternatively, a damping element 1 can be provided in which the clamping effect is produced by the wing-like clamping elements 4 in the mounted state each pressing inwards with their inner surface 4a against the surface 22a. In terms of fastening to the storage rack 20, the inner surfaces 4a of the wing-like clamping elements 4 are moved away from each other, in contrast to the above-described embodiment, and released once the damping element 1 has been positioned appropriately on the storage rack 20. The wing-like clamping elements 4 are flexible for this purpose and in particular are flat for this purpose. The inner surface 4a and an outer surface 4b of the wing-like clamping elements 4 are thus large in relation to an end face 4c connecting the inner surface 4a and outer surface 4b. The inner surface 4a of one wing-like clamping element 4 and the inner surface 4a of the other wing-like clamping element 4 lie opposite each other.

In the present instance, two nipples 6 are disposed in each case on the wing-like clamping elements 4, or rather on the outer surface 4b thereof, with which nipples form-fitting fastening of the damping element 1 to the storage rack is additionally possible. The nipples 6 are optional fastening elements.

On the outer side of the housing 2 and, in the present case, in the region of the receiving region 8, a recess 5 is also provided which can be used for form-fitting fastening of the damping element 1 to a storage rack 20 (see FIGS. 2 to 4).

The housing 2 is formed as one piece. Alternatively, the housing 2 can also be formed of multiple parts. The housing 2 can be designed e.g. as an injection molded part.

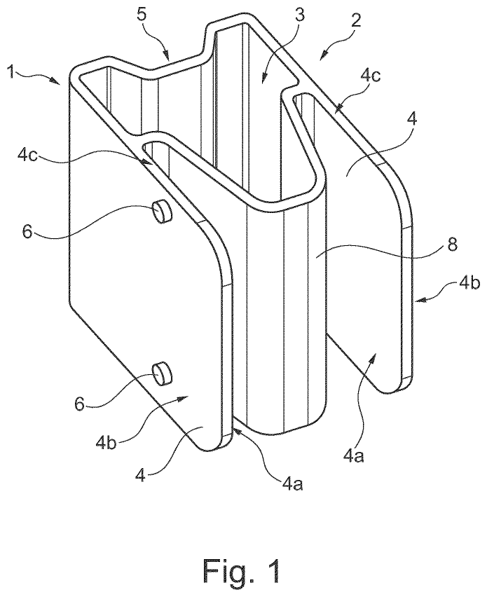

FIG. 2 shows a schematic perspective view of an embodiment of the arrangement in accordance with the invention. In addition to the damping element 1, the arrangement comprises a storage rack 20, where the damping element 1 is fastened to the storage rack 20, more precisely to a support pillar 22 of the storage rack 20. The housing 2 of the damping element 1 is designed as shown in FIG. 1. In the present case, the damping element 1 also comprises a cover 7, with which the receiving region 8 is closed in a releasable manner. Alternatively it is possible for the receiving region 8 to remain open or for the damping element 1 to be positioned on the storage rack 20 in such a way that the receiving region 8 is closed by a contour on the storage rack 20.

As already described in relation to FIG. 1, a clamping effect is produced in the present case by reason of the fact that the two wing-like clamping elements 4 each exert a pressing force onto the surface 22a of the support pillar 22 by their outer surfaces 4b. Each nipple 6 engages into a hole 22b provided on the support pillar 22 in order to secure the damping element 1 in a form-fitting manner in the vertical direction. A bulge on the support pillar 22 engages into the recess 5 provided on the housing 2 in order to secure the damping element 1 in a form-fitting manner in a horizontal direction.

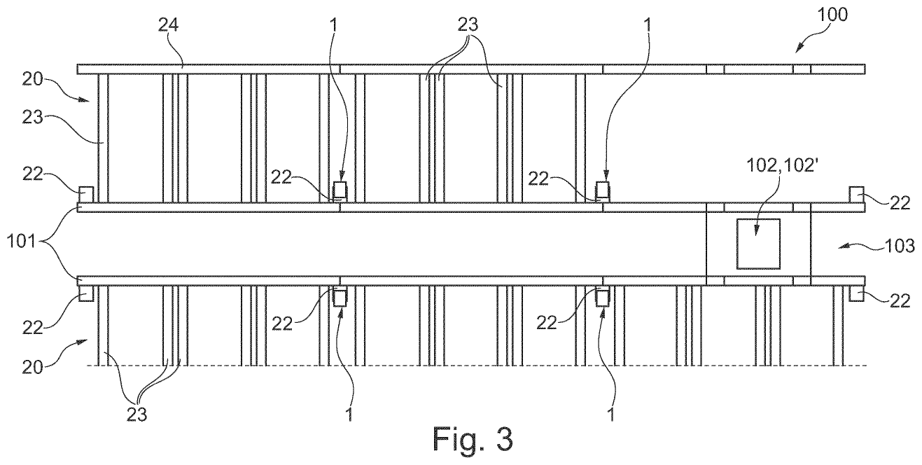

FIG. 3 shows a schematic cross-sectional view of an embodiment of the storage system 100 in accordance with the invention. The storage system 100 comprises two storage racks 20 spaced apart from each other and disposed separated by a rack aisle 103. In the illustrated view, only one rack level of the two storage racks 20 is shown. However, the storage racks 20 have further rack levels below and/or above the shown rack level.

Each of the storage racks 20 has a plurality of support pillars 22, a plurality of transverse cross members 23 and a plurality of longitudinal cross members 24. The support pillars 22 are disposed vertically on the storage rack 20. In the illustrated view, only the cross-section thereof is shown. The transverse cross members 23 are disposed horizontally on the storage rack 20 and substantially perpendicularly to the support pillars 22. The longitudinal cross members 24 are also disposed horizontally on the storage rack 20 and substantially perpendicularly to the support pillars 22 and transverse cross members 23. Since it is a schematic view, not all support pillars 22, transverse cross members 23 and longitudinal cross members 24 are shown.

Furthermore, the storage system 100 comprises a rack serving apparatus 102 which is designed as a single-level rack serving apparatus 102′ and which can travel on two rails 101 in the illustrated rack plane. In the further rack planes of the storage rack 20 which are not shown, further single-level rack serving apparatuses 102′ can be provided. A rail 101 is disposed on and fastened to one of the two storage racks 20 in each case. During travel of the single-level rack serving apparatus 102′ on the rails 101, vibrations can be produced which are transferred from the respective rail 101 to the respective storage rack 20. In each case, one of the total of four provided damping elements 1 is disposed on and fastened to a support pillar 22. Each of the damping elements 1 can be designed e.g. like the damping element 1 described in relation to FIG. 1. The grain-like damping means can be the same or different.

It is possible for further damping elements 1 to be provided on the storage rack 20, which are then e.g. disposed in and fastened to one of the transverse cross members 23 or disposed in or fastened to one of the longitudinal cross members 24.

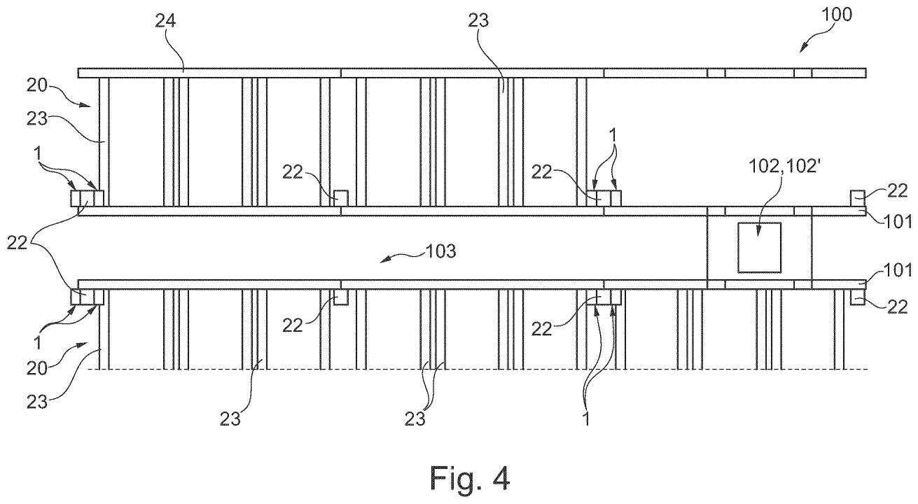

FIG. 4 shows a schematic cross-sectional view of a further embodiment of the storage system 100 in accordance with the invention. In contrast to the embodiment of the storage system 100 shown in FIG. 3, in which the damping elements 1 are disposed on the support pillars 22 of the storage rack, in the embodiment of the storage system 100 shown in this case, the damping elements 1 are disposed on the rails 101 of the single-level rack serving apparatus 102′and the support pillars 22 but are fastened only to the rails 101.

In each case, four damping elements 1 are provided per rail 101, i.e. a total of eight damping elements 1. The damping elements 1 are in each case disposed in pairs on the rail 101 and on both sides of a support pillar 22.

1. A dampener for damping vibrations on a storage rack, said dampener comprising:
a housing; and
a grain-like damping material introduced into the housing;
wherein the dampener can be fastened to the storage rack in a force-fitting and/or form-fitting manner exclusively by reason of a shape and/or a material of the housing.

2. The dampener as claimed in claim 1, wherein the housing comprises two wing-like clamping elements with which the housing can be fastened to the storage rack.

3. The dampener as claimed in claim 2, wherein the housing is an injection moulded part.

4. The dampener as claimed in claim 3, wherein a grain shape and/or a grain size or granularity of the grain-like damping material is dependent on a vibration frequency to be damped.

5. The dampener as claimed in claim 4, wherein the grain-like damping material comprises a powder and/or a granulate and/or sand.

6. (canceled)

7. (canceled)

8. (canceled)

9. (canceled)

10. The dampener as claimed in claim 1, wherein the housing is an injection molded part.

11. The dampener as claimed in claim 1, wherein a grain shape and/or a grain size or granularity of the grain-like damping material is dependent on a vibration frequency to be damped.

12. The dampener as claimed in claim 11, wherein the grain-like damping material comprises a powder and/or a granulate and/or sand.

13. The dampener as claimed in claim 1, wherein the grain-like damping material comprises a powder and/or a granulate and/or sand.

14. A storage rack which comprises storage locations for stored goods and a dampener as claimed in claim 1, wherein the dampener is fastened to the storage rack in a force-fitting and/or form-fitting manner.

15. The storage rack as claimed in claim 14, wherein the dampener is disposed on or in a support pillar and/or a transverse cross member and/or a longitudinal cross member of the storage rack.

16. The storage rack of claim 14, wherein the housing comprises two wing-like clamping elements with which the housing can be fastened to the storage rack.

17. The storage rack of claim 14, wherein the grain-like damping material comprises a powder and/or a granulate and/or sand.

18. A storage system comprising a storage rack as claimed in claim 14 and further comprising a rack serving apparatus that can travel along the storage rack and with which the stored goods can be transported.

19. The storage system as claimed in claim 18, wherein the storage rack comprises a plurality of storage racks, and wherein the rack serving apparatus is a single-level rack serving apparatus that can travel on two rails, wherein the rails extend between two storage racks disposed in parallel with each other and separated from each other by a rack aisle and in each case one of the two rails is fastened to one of the neighbouring storage racks, and wherein the damping element is disposed on or in one of the two rails.
